(19) United States
(12) Patent Application Publication
(10) Pub. No.: US 2007/0139159 A1
(43) Pub. Date: Jun. 21, 2007

(54) Clock generation circuit

(75) Inventors: Rohit Mittal, Sunnyvale, CA (US); Robert Olah, Sunnyvale, CA (US); Jyn-Bang Shyu, Cupertino, CA (US)

Correspondence Address: Zilka-Kotab, PC, P.O. BOX 721120, SAN JOSE, CA, 95172-1120, US

(73) Assignee: INTELLEFLEX CORPORATION

(21) Appl. No.: 11/305,652

(22) Filed: Dec. 15, 2005

(51) Int. Cl. H04Q 5/22

(52) U.S. Cl. 340/10.1

(57) ABSTRACT

A circuit according to one embodiment of the present invention includes a first frequency to voltage converter for storing a reference voltage based on a frequency of an incoming signal, and a second frequency to voltage converter for storing a second voltage based on the frequency of the incoming signal, the second voltage being a fraction of the reference voltage. A voltage to frequency converter creates a voltage on a node, the voltage repeatedly varying between about the reference voltage and about the second voltage. From this varying signal, a clock signal can be derived.

### FIELD OF THE INVENTION

The present invention relates to clock recovery circuits, and more particularly, this invention relates to clock recovery circuits for wireless devices.

### BACKGROUND OF THE INVENTION

Transmitting serial data from a source is normally performed by shifting pulses across a medium from one location to another. This medium can be electrical wire or Radio Frequency (RF) signals. When data is received at its destination, the clock and data must be recovered.

One technology area holding much promise for the future of data transmission is the emerging Radio Frequency Identification (RFID) technology. RFID technology employs an RF wireless link and ultra-small embedded computer chips. RFID technology enables such things as allowing physical objects to be identified and tracked via wireless “tags”.

RFID systems, and particularly tags, are designed to operate on minimal power, as passive tags rely on the RF carrier signal for energy. The farther a passive tag is from the source of the carrier signal, the less power is generated. Accordingly, the range of a passive tag from the source of the carrier signal varies as a function of the power requirements of the tag. Battery powered tags are constrained by a finite battery life, which in turn depends on power consumption. Power consumption is critical in battery powered tags since any clock recovery circuit at the front end of a serial data input retrieval will be consuming power as it continuously samples the incoming signal for an activation signal.

Thus, in a low power tag, data signals must be decoded and recovered with minimum power. Current RFID clock recovery circuits use a Phase Locked Loop/Clock Data Recovery (PLL/CDR) circuit to recover the clock from an incoming data stream. One major problem is that the PLL circuit takes a long time to lock and consumes significant area and power, which is undesirable for RFID tags. The lock time can be reduced but it can never approach 2-3 cycles of preamble because it works in a feedback loop. Another traditional method to recover data is to over-sample the data at a higher frequency than the incoming data. Both of these methods consume unacceptable amounts of power, making the methods impractical for such things as remote sensing devices.

What is needed is a low power circuit and method for recovering and decoding incoming data to generate a clock.

In addition, delays are needed to reset and reconfigure systems based on input stimulus or lack of input stimulus. These delays are traditionally generated by dividing a particular clock frequency. Since a clock does not exist, a method of creating a precise delay without a clock is needed.

### SUMMARY OF THE INVENTION

A circuit according to one embodiment of the present invention includes a first frequency to voltage converter for storing a reference voltage based on a frequency of an incoming signal, and a second frequency to voltage converter for storing a second voltage based on the frequency of the incoming signal, the second voltage being a fraction of the reference voltage. A voltage to frequency converter creates a voltage on a node, the voltage repeatedly varying between about the reference voltage and about the second voltage. From this varying signal, a clock signal can be derived.

A circuit according to another embodiment of the present invention includes a current source and a capacitor selectively coupleable to the current source. The capacitor is sequentially charged to a first voltage level and discharged to a second voltage level. A counter counts a number of times the capacitor is charged to the first voltage level, discharged to the second voltage level, or both charged to the first voltage level and discharged to the second voltage level.

A RFID system includes a plurality of RFID tags having one or more of the circuits described above and an RFID interrogator in communication with the RFID tags.

Illustrative methods of use are also presented.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of an RFID system.

FIG. 2 is a system diagram for an integrated circuit (IC) chip for implementation in an RFID tag.

FIG. 3 is a depiction of an activate command.

FIGS. 4A-C are circuit diagrams of frequency to voltage converters according to one embodiment.

FIG. 5 is a circuit diagram of a voltage to frequency converter according to one embodiment.

FIGS. 6A-6B are depictions of illustrative waveforms generated by the various embodiments.

FIG. 7 is a circuit diagram of a timing circuit according to one embodiment.

FIG. 8 is a diagram of an activate circuit according to one embodiment.

FIG. 9 is a diagram of an activate circuit according to another embodiment.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The following specification describes systems and methods which recover a clock from as few as two cycles.

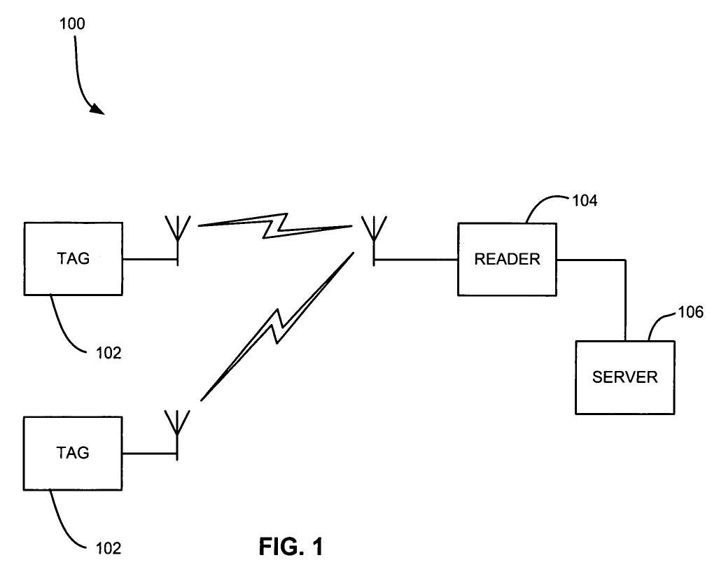

Many types of devices can take advantage of the embodiments disclosed herein, including but not limited to Radio Frequency Identification (RFID) systems and other wireless devices/systems; pacemakers; portable electronic devices; audio devices and other electronic devices; smoke detectors; etc. To provide a context, and to aid in understanding the embodiments of the invention, much of the present description shall be presented in terms of an RFID system such as that shown in FIG. 1. It should be kept in mind that this is done by way of example only, and the invention is not to be limited to RFID systems, as one skilled in the art will appreciate how to implement the teachings herein into electronics devices in hardware and/or software. Examples of hardware include Application Specific Integrated Circuits (ASICs), printed circuits, monolithic circuits, reconfigurable hardware such as Field Programmable Gate Arrays (FPGAs), etc. Further, the methodology disclosed herein can also be incorporated into a computer program product, such as a computer disc containing software. Further, such software can be downloadable or otherwise transferable from one computing device to another via network, nonvolatile memory device, etc.

As shown in FIG. 1, an RFID system 100 includes a tag 102, a reader 104, and an optional server 106. The tag 102 includes an IC chip and an antenna. The IC chip includes a digital decoder needed to execute the computer commands that the tag 102 receives from the tag reader 104. The IC chip also includes a power supply circuit to extract and regulate power from the RF reader; a detector to decode signals from the reader; a backscatter modulator, a transmitter to send data back to the reader; anti-collision protocol circuits; and at least enough memory to store its EPC code.

Communication begins with a reader 104 sending out signals to find the tag 102. When the radio wave hits the tag 102 and the tag 102 recognizes and responds to the reader's signal, the reader 104 decodes the data programmed into the tag 102. The information is then passed to a server 106 for processing, storage, and/or propagation to another computing device. By tagging a variety of items, information about the nature and location of goods can be known instantly and automatically.

Many RFID systems use reflected or “backscattered” radio frequency (RF) waves to transmit information from the tag 102 to the reader 104. Since passive (Class-1 and Class-2) tags get all of their power from the reader signal, the tags are only powered when in the beam of the reader 104.

The Auto ID Center EPC-Compliant tag classes are set forth below:

Class-1
Identity tags (RF user programmable, maximum range 3 m)
Lowest cost

Class-2
Memory tags (8 bits to 128 Mbits programmable at maximum 3 m range)
Security & privacy protection
Low cost

Class-3
Semi-Active tags
Battery tags (256 bits to 64 Kb)
Self-Powered Backscatter (internal clock, sensor interface support)
100 meter range
Moderate cost

Class-4
Active tags
Active transmission (permits tag-speaks-first operating modes)
Up to 30,000 meter range
Higher cost

In RFID systems where passive receivers (i.e., Class-1 and Class-2 tags) are able to capture enough energy from the transmitted RF to power the device, no batteries are necessary. In systems where distance prevents powering a device in this manner, an alternative power source must be used. For these “alternate” systems (also known as active or semi-active), batteries are the most common form of power. This greatly increases read range, and the reliability of tag reads, because the tag doesn't need power from the reader. Class-3 tags only need a 10 mV signal from the reader in comparison to the 500 mV that a Class-1 tag needs to operate. This 2,500:1 reduction in power requirement permits Class-3 tags to operate out to a distance of 100 meters or more compared with a Class-1 range of only about 3 meters.

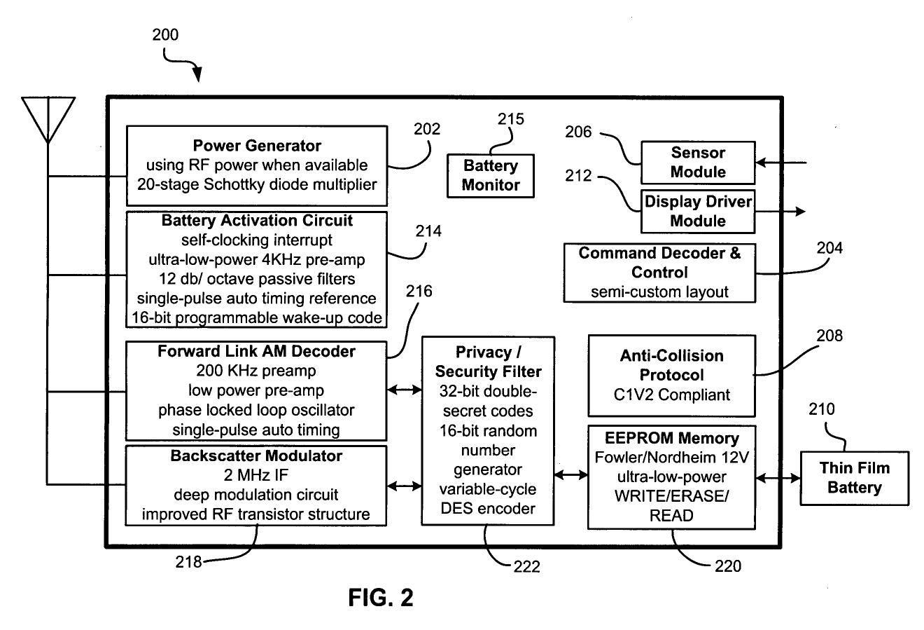

Embodiments of the present invention are preferably implemented in a Class-3 or higher Class chip. FIG. 2 depicts a circuit layout of a Class-3 chip 200 according to an illustrative embodiment for implementation in an RFID tag. This Class-3 chip can form the core of RFID chips appropriate for many applications such as identification of pallets, cartons, containers, vehicles, or anything where a range of more than 2-3 meters is desired. As shown, the chip 200 includes several industry-standard circuits including a power generation and regulation circuit 202, a digital command decoder and control circuit 204, a sensor interface module 206, a C1V2 interface protocol circuit 208, and a power source (battery) 210. A display driver module 212 can be added to drive a display.

A battery activation circuit 214 is also present to act as a wake-up trigger. In brief, the battery activation circuit 214 includes an ultra-low-power, narrow-bandwidth preamplifier with an ultra low power static current drain. The battery activation circuit 214 also includes a self-clocking interrupt circuit and uses an innovative user-programmable digital wake-up code. The battery activation circuit 214 draws less power during its sleeping state and is much better protected against both accidental and malicious false wake-up trigger events that otherwise would lead to pre-mature exhaustion of the Class-3 tag battery 210.

A battery monitor 215 can be provided to monitor power usage in the device. The information collected can then be used to estimate a useful remaining life of the battery.

A forward link AM decoder 216 uses a simplified phase-lock-loop oscillator that requires an absolute minimum amount of chip area. Preferably, the circuit 216 requires only a minimum string of reference pulses.

A backscatter modulator block 218 preferably increases the backscatter modulation depth to more than 50%.

A memory cell, e.g., EEPROM is also present. In one embodiment, a pure, Fowler-Nordheim direct-tunneling-through-oxide mechanism 220 is present to reduce both the WRITE and ERASE currents to less than 0.1 μA/cell in the EEPROM memory array. Unlike any RFID tags built to date, this will permit designing of tags to operate at maximum range even when WRITE and ERASE operations are being performed.

The module 200 may also incorporate a highly-simplified, yet very effective, security encryption circuit 222. Other security schemes, secret handshakes with readers, etc. can be used.

Only four connection pads (not shown) are required for the chip 200 to function: Vdd to the battery, ground, plus two antenna leads to support multi-element omni-directional antennas. Sensors to monitor temperature, shock, tampering, etc. can be added by appending an industry-standard I2C interface to the core chip.

It should be kept in mind that the present invention can be implemented in any type of tag, and the circuit 200 described above is presented as only one possible implementation.

The present invention describes a clock generation circuit that can create a clock signal in as few as two cycles. Some embodiments of the present invention generate the clock based on an incoming data signal. Other embodiments of the present invention use a known current and capacitance to generate a clock signal for such things as timeouts, etc. Further embodiments do both. To place the invention in context, much of the description will be written in terms of a tag activation process. However, it is to be understood that the circuits described herein have application beyond such activation processes and systems.

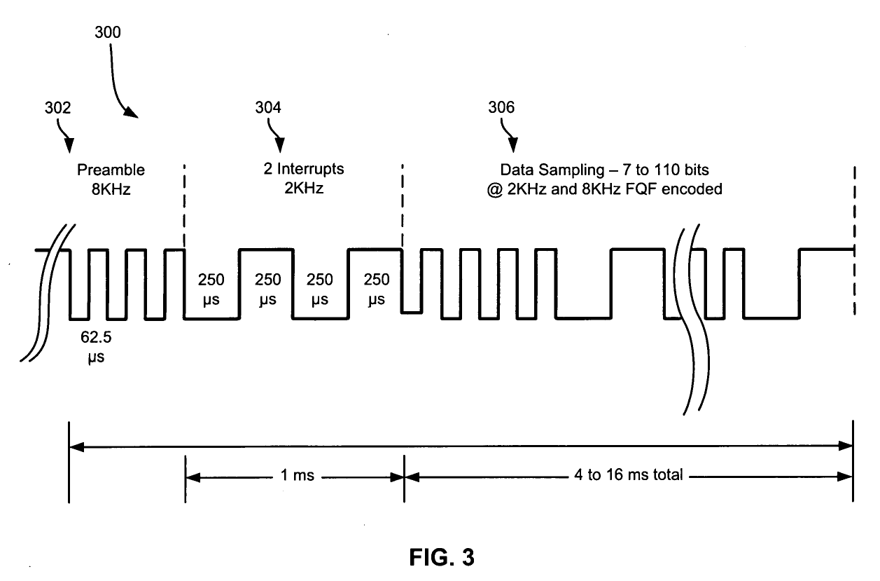

FIG. 3 illustrates an exemplary incoming data signal waveform 300. In this example, the waveform 300 is of an activate command of the type used in an activate circuit described in copending U.S. patent application Ser. No. 11/007,973 filed Dec. 8, 2004 with title “BATTERY ACTIVATION CIRCUIT”, which is incorporated by reference herein.

The basic features of the “Activate” command 300 are:
A preamble 302 including an optional clock synchronization section. This section may be used by the circuits described below to define the clocking period.
An interrupt 304 to synchronize the start of a command with sufficient difference from “normal” commands (such as a timing violation in the forward communications protocol, or a “cluster” of bits that the device recognizes as an interrupt). This section may be used by the circuits described below to define the clocking period.
An activate code 306 to allow potentially selective, subset of all tags, or all-inclusive tag activation.

The preamble portion 302 of the Activate command 300 preferably includes a predefined clock synchronization signal at an incoming rate of, for example, 8 KHz.

The next section is the Interrupt or violation section 304. This may include, for example, two cycles of 50% duty cycle based on a 2 KHz incoming rate. The interrupt marks the beginning of the code section which is the third component of the Activate command. By observing the interrupt portion 304, the receiver (tag) will realize that it has received an “Activate” command. Correct reception of the interrupt portion 304 moves the tag from the hibernate state into the code search state. A device (tag) preferably will only stay in the code search state for a maximum time period, such as 1-5 ms, preferably ˜2 ms. If the tag is not moved into the ready or active state within that time, the tag will automatically revert back into the hibernate state. A circuit for generating a timeout period without requiring a running clock is also described below.

The receiving device listens for the interrupt, in this example a logic 1-1 in sequence. Upon encountering any logic 1-1, the device then processes the incoming activate code 306 as described below. If a value in the next sequence of bits matches a value stored locally on the receiving device, the device wakes up. If one of the bits in the sequence fails to match, the device resets, looks for the next interrupt, and begins monitoring the sequence of bits after the next interrupt (here, logic 1-1). It should be noted that a logic 1-1 in the activate code portion 306 will not cause the device to begin analyzing the incoming bit stream again because the interrupt detection circuit will not function after issuing an interrupt signal until either the activation code search is completed or a pre-set time-out period is reached. However, if the code does not match the device will reset again.

The activate code portion 306, according to one embodiment, can be described in two parts: first the signaling or communications protocol, and second the command protocol. Signaling in one embodiment can be described as two different frequencies where a one is observed as a 2 KHz tone and a zero is observed as an 8 KHz tone (or vice versa). These two tones (otherwise described as FQF for frequency, quad frequency) describe a command, which when matching an internal register, move the tag from a hibernate state to an active state (ready state in the state machine).

While the tag is waiting to activate, preferably no clock is running in order to minimize power consumption. The following description describes how a clock signal can be derived from an incoming activate command 300. Note that the reference signal need not be an activate command, but rather can be any incoming signal.

With a specific incoming data sequence of known pulse widths, such as in the preamble portion 302 or interrupt portion 304 of the activate command 300, the frequency can be determined using a frequency to voltage converter to store a voltage corresponding to the reference frequency of the input data. When a voltage V featuring a slope dT is applied to a capacitor C, it pushes a current into the capacitor of: I=C*dV/dT. Making use of the relationship I=C*dV/dT, the input frequency can be stored on a capacitor by converting the incoming signal to an input voltage. The stored charge can then be used to recreate the input frequency. This is accomplished by using a current to charge a capacitor during the first clock cycle. As soon as the first cycle ends, as defined by either the rising edge or falling edge of the incoming data signal, the current is disengaged. Hence the voltage is stored.

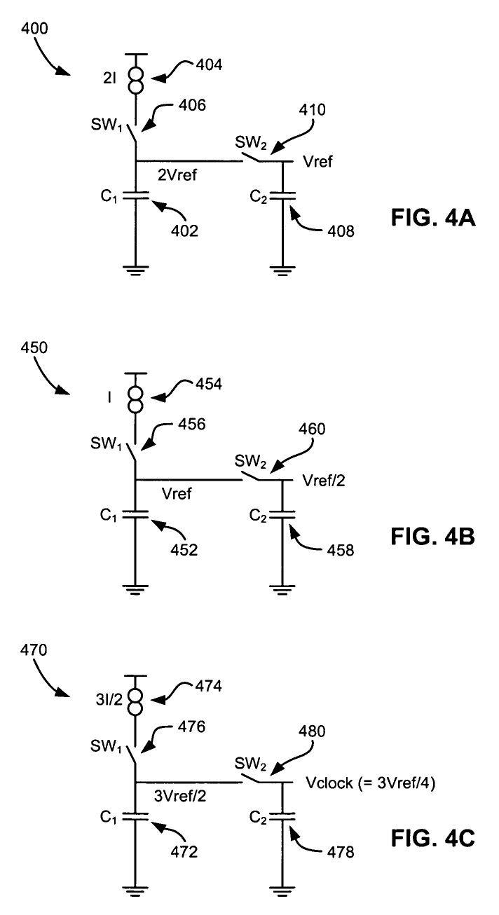

Two such frequency to voltage converters store the reference (Vref) and a second voltage that is any fraction of Vref, such as reference/2 (Vref/2) levels. These are the values between which the output will oscillate. Circuits that may be used to store the reference voltages are shown in FIGS. 4A and 4B. Particularly, FIG. 4A shows a circuit 400 that will store Vref and FIG. 4B shows a circuit 450 that will store Vref/2. As shown in FIG. 4A, the circuit 400 includes a first capacitor (C₁) 402, a current source 404, a first switch (SW₁) 406 separating the first capacitor 402 from the current source 404, a second capacitor (C₂) 408, and a second switch (SW₂) 410 separating the first and second capacitors.

As shown in FIG. 4B, a second circuit 450 includes a first capacitor (C₁) 452, a current source 454, a first switch (SW₁) 456 separating the first capacitor 452 from the current source 454, a second capacitor (C₂) 458, and a second switch (SW₂) 460 separating the first and second capacitors. Note that the capacitors in the first and second circuits 400, 450 are preferably substantially the same. However, the current source 454 of the second circuit 450 provides one half the current as the current source 404 in the first circuit 400.

In an example of use, on the first falling edge of the interrupt pulse 304 (FIG. 3), the first switch 406 closes, charging the first capacitor 402 to 2Vref with current 2I. At the next falling edge of the interrupt pulse, the first switch 406 opens and the second switch 410 closes, transferring half the charge to the second capacitor 408, where the second capacitor 408 is the same size as the first capacitor 402.

In the second circuit 450, on the first falling edge of the interrupt pulse 304 (FIG. 3), the first switch 456 closes to charge the first capacitor 452 to Vref with current I. At the next falling edge of the interrupt pulse, the first switch 456 opens and the second switch 460 closes, transferring half the charge to the second capacitor 458, where the second capacitor 458 is the same size as the first capacitor 452. One skilled in the art will appreciate that the capacitors of the various circuits need not be identical. However, if the capacitors are different, other parameters such as the incoming current level, etc. may be varied to provide similar functionality to that described in this example.

Accordingly, the circuits 400, 450 store voltages that represent the frequency of the incoming data signal.

A third frequency to voltage converter circuit 470, shown in FIG. 4C, functions in the same way as the circuits 400, 450 shown in FIGS. 4A-B. However, this circuit 470 stores a clock reference voltage (Vclock) that is at some level between Vref and Vref/2. For reasons that will soon become apparent, it may be desirable that Vclock be about 3Vref/4 in order to create a cock signal of about identical periods. However, if an irregular duty cycle is acceptable, Vclock can be any voltage between Vref and Vref/2. The use of the reference voltages Vref, Vref/2, and Vclock to generate a clock signal will now be described.

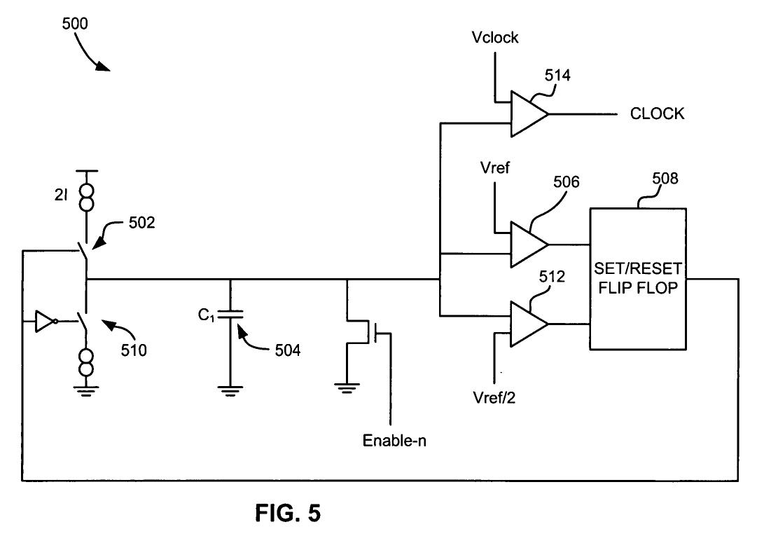

To generate a clock signal based on this stored voltage, a voltage to frequency converter is used. FIG. 5 illustrates one such voltage to frequency converter 500. When a tag (or portion thereof) is operational, the clock is enabled by Enable_N going low. A switch 502 connects the current to charge capacitor 504 at a rate equal to the stored frequency voltage. When capacitor 504 is charged to Vref, a comparator 506 comparing the voltage of the capacitor 504 with Vref from circuit 400 (FIG. 4A) switches a set-reset flip-flop 508, opening switch 502 and closing switch 510. The capacitor 504 is then discharged at the same rate of charging until it reaches Vref/2. When the capacitor 504 reaches Vref/2, a second comparator 512 comparing the output of the capacitor 504 with Vref/2 from circuit 450 (FIG. 4B) switches the set-reset flip-flop 508, closing switch 502 and opening switch 510, which causes the capacitor 504 to begin charging again towards Vref. This functionality will continue, creating a saw tooth wave with the same frequency as the input wave until Enable_n goes high stopping the clock. A comparator 514 comparing a clock voltage (Vclock) from circuit 480 (FIG. 4C) to the voltage of the capacitor 504 translates this saw-tooth wave into a square wave having a frequency very similar to that of the incoming signal.

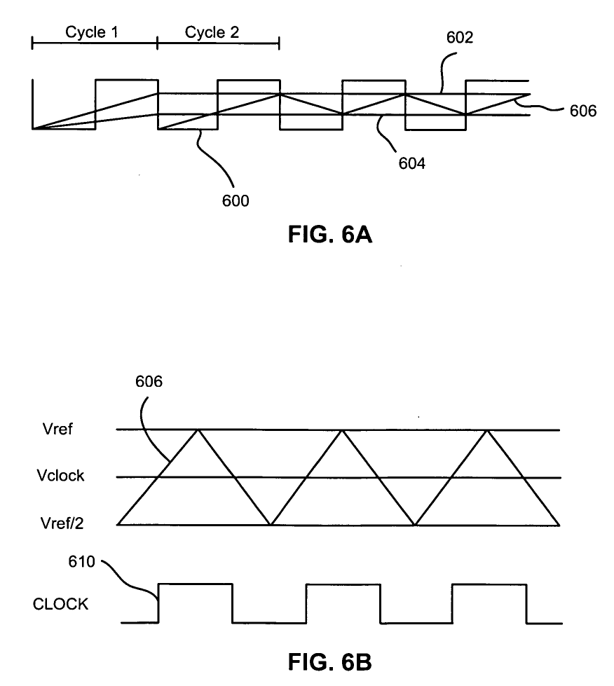

FIG. 6A illustrates the relationship between the incoming clock signal 600, Vref 602, Vref/2 604, and the sawtooth waveform 606 of the voltage on the node between the capacitor 504 and comparator 514 (FIG. 5).

FIG. 6B depicts the relationship between the sawtooth waveform 606 and associated clock signal 610 as would be present at the output from comparator 514.

Accordingly, a clock signal can be generated from two rising or falling edges of an incoming signal. This is a self-sustaining scheme and no input is required.

When there is no clock generated, as before a circuit goes into activation, a timeout mechanism may be desirable. For instance, when a tag has generated an interrupt and is then looking for the activation sequence but does not activate, the tag should return to hibernate after a period of time to conserve battery. However, this would require a timer, which in turn requires a clock signal. Since there may be no clock before activation, such a time out would need to be created by other means. Advantageously, the time out period and signal can be created with a known current I and a known capacitor.

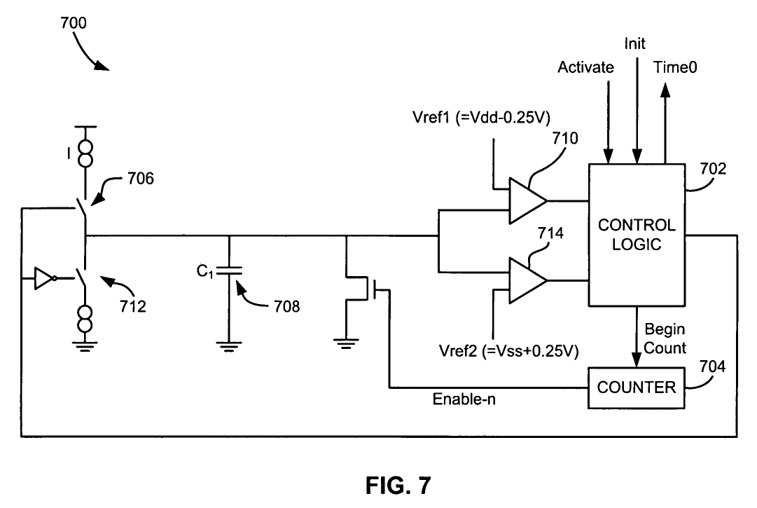

A timing circuit 700 to create this time out period and signal is shown in FIG. 7. The timing circuit 700 may generate, for example, a timeout delay, an elapsed time, etc. In the embodiment shown, a saw tooth pattern is generated that is related to a frequency approximated based on the known current and capacitor. The particular frequency cycles are counted and after the particular time (based on number of cycles or portions thereof), if an event has not occurred, appropriate system configuration occurs, which may include deactivation of the clock for example. In the activation example, if activation has not occurred after a predetermined number of cycles, the tag will return to hibernate and look for the interrupt sequence.

With continued reference to FIG. 7, a logic module 702 controls initialization of the circuit 700. Continuing with the activation example, once the tag detects an interrupt in the incoming data stream, it sends an Init signal to the logic module 702. The logic module then sends a Begin Count signal to a counter 704. The counter 704 counts the number of clock cycles, and until the appropriate delay is reached, sets Enable-n low, starting clock generation.

The delay frequency is represented by: I/C*dV. A switch 706 connects a known current I to charge capacitor 708. As the capacitor charges, a comparator 710 compares the voltage of the capacitor 708 with a first reference voltage (Vref1). Vref1 can be a predetermined voltage, a voltage in use by the device, etc. In the embodiment shown, Vref1 equals Vdd-0.25V where Vdd>Vss.

When the capacitor voltage reaches Vref1, the comparator 710 sends a signal to the logic module 702, which sends a signal to the counter 704, for e.g., increasing the count by one if counting up or decreasing the count by one if counting down. The logic module 702 also opens switch 706 and closes switch 712. The capacitor 708 then discharges at the same rate as the rate of charging until it reaches a second reference voltage. When the capacitor 708 reaches the second voltage, a second comparator 714 comparing the voltage of the capacitor 708 with a second reference voltage (Vref2) sends a signal to the logic module 702, which opens switch 712 and closes switch 706. This causes the capacitor 708 to begin charging again. This functionality will continue, creating a saw tooth wave with a constant frequency. The clocks are counted by the counter 704 and when the count reaches a predetermined value, e.g., timeout value, Enable_n goes high stopping the clock. In the activation example, upon receiving a timeout signal (TimeO) or at the end of activation time, the backend activation circuit is configured to return to waiting for the interrupt frequency in hibernate mode.

Additionally, the logic module 702 may receive an Activate command indicating that the device has activated. The logic module 702 may then instruct the counter to set Enable-n high to stop the count.

To measure an elapsed time, based on a number of cycles, the count in the counter can be queried by the logic module 702 or other component of the host system. Note also that the logic module may be an ASIC, may be running software, may be reconfigurable logic, etc. as mentioned above, and need not be an integral portion of the circuit.

The battery activation circuit 214 (FIG. 2) described herein may be used in communication between two devices where a transmitter wants to activate or enable a receiving device via the Radio Frequency (RF) medium. While this circuitry anticipated for use in RFID systems, it is by no means restricted to just that industry. This disclosure describes an activation circuit where the preferred description and embodiment relates to RFID, but is by no means only restricted to that technology. Consequently, any system which requires an entity (e.g., transmitter) to alert another entity (e.g., reader) applies to this idea without regard to the medium used (e.g., RF, IR, cable, etc).

Within Class-3 (and higher Class) tags, preserving the battery life by segregating which devices are activated will also help in power management. Selection criteria used to activate or power on only those tags for which communication is necessary will preserve, as best as possible, battery life. In selections of a subsets of tags which reside in the field for the e.g., Class-3 mode, tags may be selectively activated, then accessed, then placed back into their hibernate (or other low power) state, and the next set of tags selectively activated. Enabling an activation selection process for large quantities of resident tags in the field at one time, but less than all tags in the field at one time, provides for the best power management strategy.

In order to reduce current draw and increase the life of battery resources, an activation or “activate” command is used. As mentioned above with reference to FIG. 3, this activate command according to a preferred embodiment includes three parts. The first part is a preamble. The second part is an interrupt (also known as a violation). The last part is a digital user activate command code. These three parts conceptually create the activate protocol. These steps must be sufficiently separated in combination from “other normal” or common traffic as to be able to decipher the activation command from other commands or noise in, for example, Class-1, Class-2 or Class-3 devices. Each of these three components was described above in conjunction with FIG. 3. It should be kept in mind that the numbers of bits, number of cycles, frequencies, memory locations, etc. can vary from those used for illustrative purposes herein.

The activate scheme described herein is also useful in all RF devices with or without batteries for the purpose of selectively selecting individual or a subgroup of particular devices.

One skilled in the art will appreciate that the following circuitry will function with a signal as described with reference to FIG. 3.

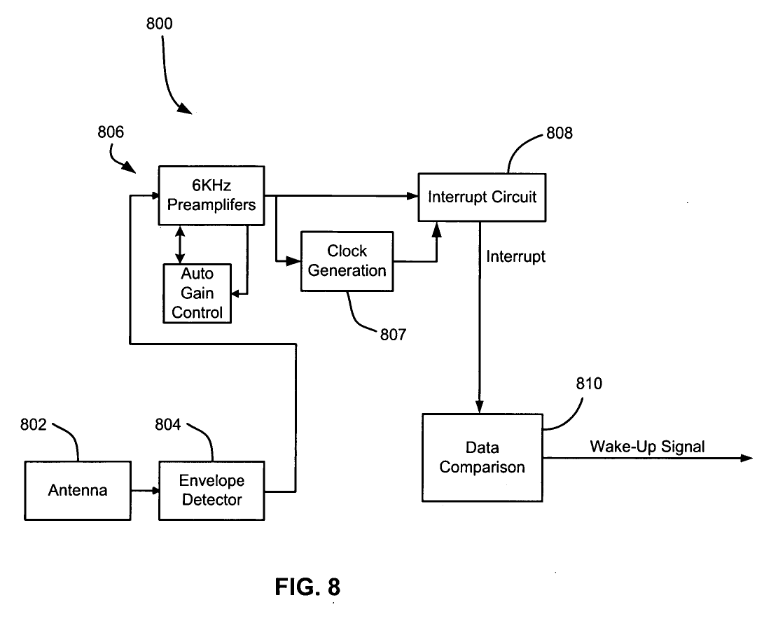

The block diagram of an illustrative activation system 800 used to implement a preferred method of the activate function is shown in FIG. 8. The system 800 is found on the front end of an RFID tag device (or other device). The incoming signal is received by the antenna 802 and passed to an envelope detector 804. The envelope detector 804 may also provide band pass filtering and amplification. The bias of the amplification stage 806 may also beset during the clock tuning phase. The preamplifier and gain control of the amplification stage 806 may have a self-biasing circuit that allows the circuit to self-adjust the signal threshold to account for any noise in the signal.

A clock generation circuit 807 generates a clock signal from the incoming data signal. The clock generation circuit 807 may include one or more of the circuits shown in FIGS. 3A-5 and 7.

The next several sections deal with collecting this filtered and amplified signal, and trying to match the incoming information to the activate command. In the interrupt circuit 808, observation of incoming information is compared to the interrupt period to match the observed signal to the required interrupt period. If successful, an interrupt signal is sent to a data comparison section 810, alerting it of an incoming digital activate code. The data comparison section 810 is used to observe the activate command and compare the received value to the tag's stored value. If the values match, the tag (device) is sent a “wake-up” signal, bring the tag to a fully active state (battery powered).

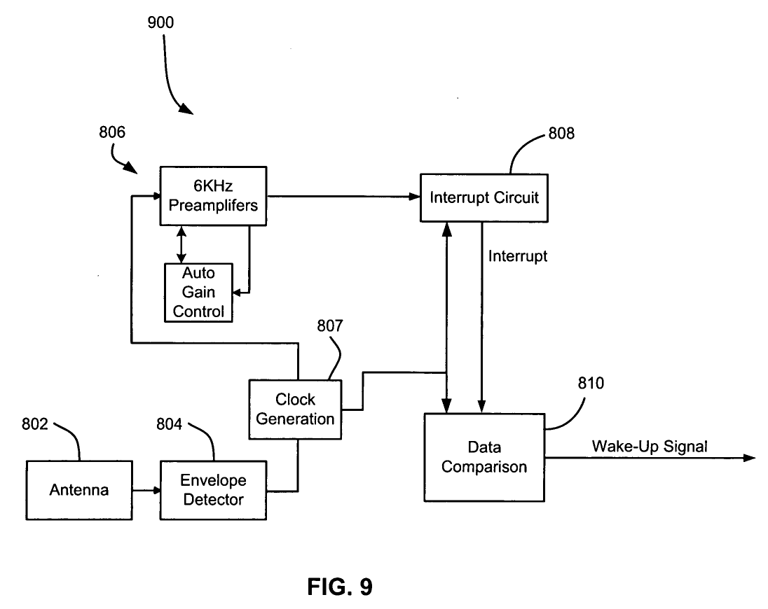

FIG. 9 illustrates another circuit 900, similar to the circuit 800 of FIG. 8, except that the clock generation circuit 807 is positioned before the amplification stage 806.

While one skilled in the art will appreciate how to implement the circuits 800, 900 of FIGS. 8-9, details about various components 804, 806, 808, 810 are described in detail in copending U.S. patent application Ser. No. 11/007,973 filed Dec. 8, 2004 with title “BATTERY ACTIVATION CIRCUIT”, which has been incorporated by reference above.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A circuit, comprising:
a first frequency to voltage converter for storing a reference voltage based on a frequency of an incoming signal;
a second frequency to voltage converter for storing a second voltage based on the frequency of the incoming signal, the second voltage being a fraction of the reference voltage;
a voltage to frequency converter coupled to the first and second frequency to voltage converters, the voltage to frequency converter creating a voltage on a node, the voltage repeatedly varying between about the reference voltage and about the second voltage.

2. A circuit as recited in claim 1, wherein the frequency to voltage converters each include a first capacitor that charges during a first cycle of the incoming signal, a second capacitor that charges from the first capacitor during a second cycle of the incoming signal, and switches for selectively isolating the capacitors.

3. A circuit as recited in claim 1, wherein the voltage to frequency converter includes a capacitor on the node, wherein the following procedure is performed sequentially: the capacitor is charged until it has a voltage level matching the reference voltage, thereafter the capacitor is discharged until it has a voltage level matching the second voltage.

4. A circuit as recited in claim 3, further comprising a comparator on the same node as the capacitor of the voltage to frequency converter, wherein the comparator compares the voltage on the node to a third voltage, the third voltage being lower than the reference voltage and higher than the second voltage, the comparator generating a square waveform.

5. A circuit as recited in claim 4, further comprising a third frequency to voltage converter coupled to the comparator, the third frequency to voltage converter being for storing the third voltage based on the frequency of the incoming signal.

6. A circuit as recited in claim 1, further comprising an interrupt circuit for detecting a particular pattern in the incoming signal, the voltage to frequency converter generating a clock signal, the interrupt circuit using the clock signal when detecting the pattern in the incoming signal.

7. A circuit as recited in claim 1, wherein the incoming signal is a radio frequency signal.

8. A circuit as recited in claim 7, wherein the circuit is part of an activation system of a Radio Frequency Identification (RFID) tag.

9. A Radio Frequency Identification (RFID) system, comprising:
a plurality of RFID tags having the circuit of claim 1; and
an RFID interrogator in communication with the RFID tags

10. A method for generating a clock signal, comprising:
storing a reference voltage based on a frequency of an incoming signal;
storing a second voltage based on the frequency of the incoming signal, the second voltage being a fraction of the reference voltage;
creating a voltage on a node, the voltage repeatedly varying between about the reference voltage and about the second voltage; and
generating a clock signal based on the varying voltage on the node.

11. A method as recited in claim 10, wherein the clock signal is generated by comparing the varying voltage on the node to a third voltage, the third voltage being lower than the reference voltage and higher than the second voltage.

12. A method as recited in claim 10, wherein the voltage on the node is caused to vary by performing the following procedure sequentially: charging a capacitor coupled to the node until the capacitor has a voltage level matching the reference voltage, thereafter discharging the capacitor until the capacitor has a voltage level matching the second voltage.

13. A method as recited in claim 10, wherein the incoming signal is a radio frequency signal.

14. A Radio Frequency Identification (RFID) system, comprising:
a plurality of RFID tags performing the method of claim 10; and
an RFID interrogator in communication with the RFID tags

15. A circuit, comprising:
a current source;
a capacitor selectively coupleable to the current source, wherein the capacitor is sequentially charged to a first voltage level and discharged to a second voltage level; and
a counter for counting a number of times the capacitor is charged to the first voltage level, discharged to the second voltage level, or both charged to the first voltage level and discharged to the second voltage level.

16. A circuit as recited in claim 15, wherein the circuit generates a timeout delay.

17. A circuit as recited in claim 16, wherein charging of the capacitor is suspended upon elapsing of the timeout delay.

18. A circuit as recited in claim 15, wherein the circuit is part of an activation system of a host device.

19. A circuit as recited in claim 18, wherein charging of the capacitor is suspended upon activation of the host device.

20. A Radio Frequency Identification (RFID) system, comprising:
a plurality of RFID tags having the circuit of claim 15; and
an RFID interrogator in communication with the RFID tags

21. A method for generating a clock signal, comprising:
creating a voltage on a node, the voltage repeatedly varying between about a reference voltage and about a second voltage, the second voltage being a fraction of the reference voltage; and
counting a number of times the voltage reaches the first voltage level, reaches the second voltage level, or reaches both the first voltage level and the second voltage level.

22. A Radio Frequency Identification (RFID) system, comprising:
a plurality of RFID tags performing the method of claim 21; and
an RFID interrogator in communication with the RFID tags
